(19) United States
(12) Patent Application Publication
(10) Pub. No.: US 2014/0170632 A1
(43) Pub. Date: Jun. 19, 2014

(54) Toilet Training Apparatuses

(71) Applicant: Sheeten Doshi, Portland, OR (US)

(72) Inventor: Sheeten Doshi, Portland, OR (US)

(21) Appl. No.: 13/718,943

(22) Filed: Dec. 18, 2012

(51) Int. Cl. G09B 5/00

(52) U.S. Cl. CPC G09B 5/00
USPC 434/365

(57) ABSTRACT

The present disclosure is directed to a toilet training apparatus for use by a user with a toilet including a bowl and a tank when the user is facing the tank and sitting on or squatting above the bowl. In some examples, the toilet training apparatus further includes a support member mounted to the toilet in a position between the bowl and the tank and at least selectively moveable to a position proximate the tank, the support member including an interaction face distal the tank when the support member is in position proximate the tank, and an interaction feature supported on the interaction face of the support member and configured to entertain the user as the user interacts with the interaction feature when the user is facing the tank and sitting on or squatting on the bowl. In other examples, the toilet training apparatus includes a support member that is integrally formed with a sleeve member. In some further examples, the support member is a rigid member that is substantially the same shape as the toilet lid and can be removably clamped to the toilet lid.

### BACKGROUND

The present disclosure relates generally to toilet training apparatuses. In particular, toilet training apparatuses with an interchangeable interactive feature are described.

One of the major challenges faced by many child care providers and parents alike is the difficulty of potty training toddlers and young children. The unenviable task of luring toddlers to the toilet can be extremely time consuming and very frustrating. Past methods of attaching games or other apparatuses to the toilet for the purpose of attracting toddlers to go potty have been wide unsuccessful for a variety of reasons. Either the apparatus is not configured in a manner that allows it to be easily attached to a toilet lid, or the toddler loses interest in the apparatus over time because it offers little or no variation in the entertainment it provides to the child. Thus, the child becomes uninterested with the apparatus and essentially all potty-training efforts are thwarted by the child's boredom with the apparatus.

Known toilet training apparatuses are not entirely satisfactory for the range of applications in which they are employed. For example, existing toilet training apparatuses having an interactive feature are not capable of being attached to a toilet lid temporarily. In addition, conventional toilet training apparatuses having an interactive feature do not have the interchangeability offered by the present invention.

Thus, there exists a need for toilet training apparatuses that improve upon and advance the design of known toilet training apparatuses. Further, there exists a need for toilet training apparatuses that are transportable and temporarily attachable to any toilet lid. Examples of new and useful toilet training apparatuses relevant to the needs existing in the field are discussed below.

### SUMMARY

The present disclosure is directed to a toilet training apparatus for use by a user with a toilet including a bowl and a tank when the user is facing the tank an sitting on or squatting above the bowl. In some examples, the toilet training apparatus further includes a support member mounted to the toilet in a position between the bowl and the tank and at least selectively moveable to a position proximate the tank, the support member including an interaction face distal the tank when the support member is in position proximate the tank, and an interaction feature supported on the interaction face of the support member and configured to entertain the user as the user interacts with the interaction feature when the user is facing the tank and sitting on or squatting on the bowl. In other examples, the toilet training apparatus includes a support member that is integrally formed with a sleeve member. In some further examples, the support member is a rigid member that is substantially the same shape as the toilet lid and can be removably clamped to the toilet lid.

### BRIEF DESCRIPTION OF THE DRAWINGS

FIG. 1 is a perspective view of first example of a toilet training apparatus.

FIG. 2 is a perspective view of a second example of a toilet training apparatus including an elastic band.

FIG. 3 is a perspective view of the toilet training apparatus in use as shown in FIG. 1.

FIG. 4 is a perspective view of a third example of a toilet training apparatus.

FIG. 5 is a perspective view of a fourth example of a toilet training apparatus including a plurality of clamps.

FIG. 6 is a perspective view of a fifth example of a toilet training apparatus.

### DETAILED DESCRIPTION

The disclosed toilet training apparatus will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and eve contemplated variation is not individually described in the following detailed description.

Throughout the following detailed description, examples of various toilet training apparatuses are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

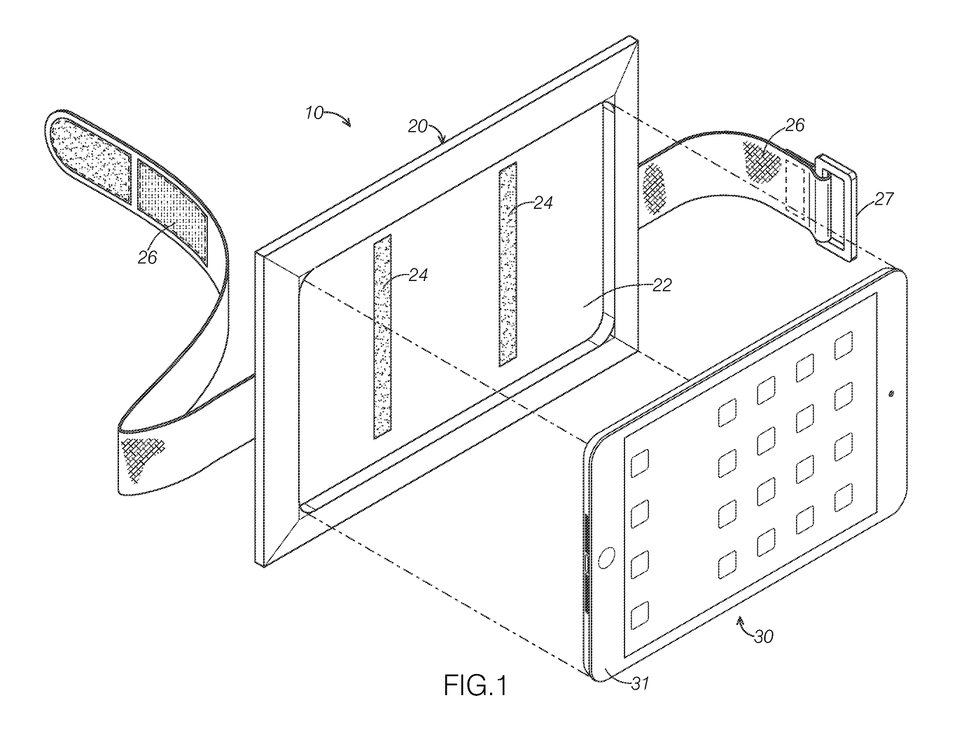

With reference to FIG. 1, a first example of a toilet training apparatus 10 will now be described. Toilet training apparatus includes a support member 20, and an interaction feature 30. Toilet training apparatus 10 functions as a toilet training device that can be easily attached and removed to any toilet lid. Additionally, toilet training apparatus 10 may be integrally formed with the toilet lid or can be affixed the toilet lid with a variety different attachment mechanisms.

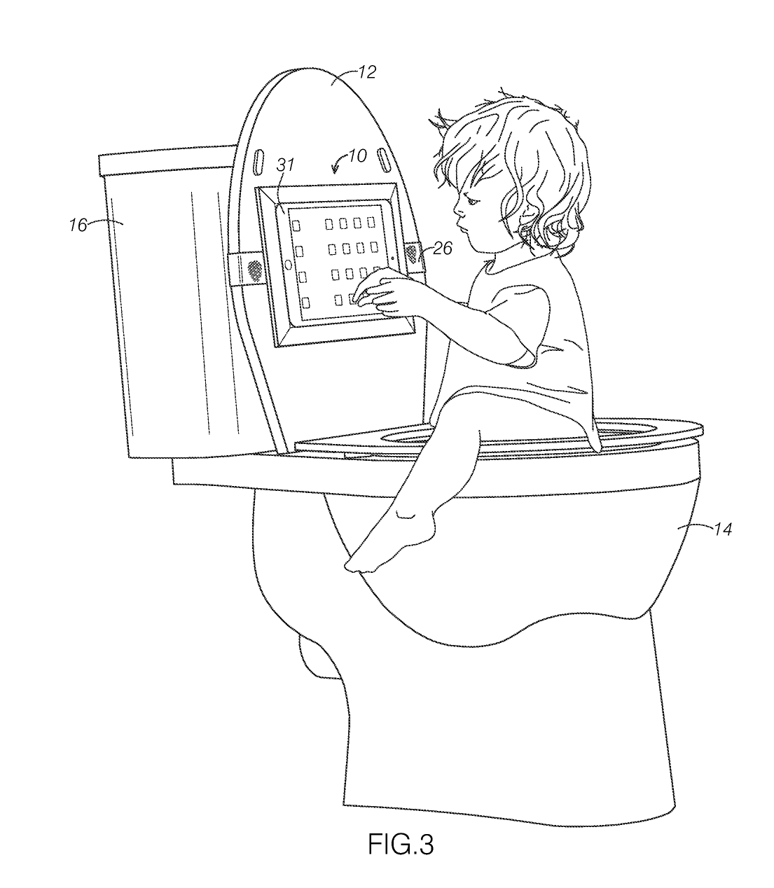

Toilet training apparatus 1 is designed to assist parents in potty training their toddlers by attaching apparatus 10 to a toilet lid 12 that is positioned between a toilet tank 16 and toilet bowl 14 as shown in FIG. 3. In this way, the operation of neither toilet lid 12 nor toilet bowl 16 is affected when apparatus 10 is being used for potty training.

Further, toilet training apparatus 10 is configured to: 1) boost the confidence of the child and sense of accomplishment, 2) reduce frustration on the part of the child and the parent; and 3) reduce the cost of diapers because of quicker and more efficient toilet training learned by the child.

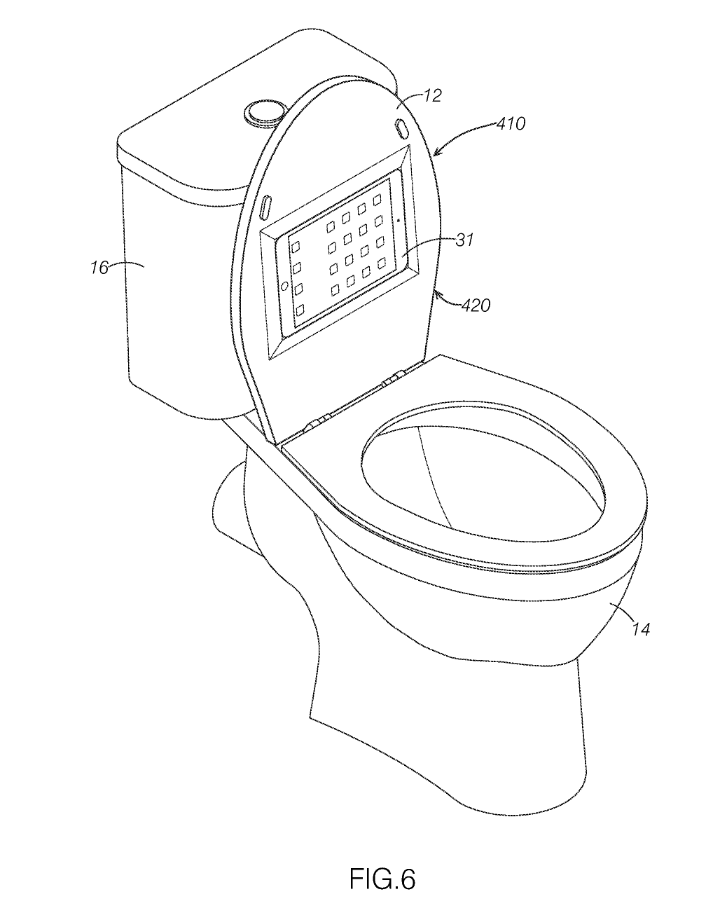

As can be seen in FIGS. 1 and 3, toilet training apparatus 10 comprises a support member 20 and interaction feature 30. In the example of FIG. 1, interaction feature 30 may be an electronic device 31, including, but not limited to an iPad Mini® or a Kindle Fire®. As shown in FIGS. 6 and 7, interaction feature 30 may be an etch-a-sketch device 34, a dry-erase board 36, or even a pinball-type game 32. Additionally or alternatively=, the interaction feature may be any game, toy, drawing medium, or device not known or later developed that would appeal to a child's interest.

Support member 20 further comprises an interaction face 22, a plurality of hook-and-loop strips 24, and a plurality of hook-and-loop straps 26. Support member 20 is mounted to lid 12 with hook-and-loop straps 26 and buckle 27 in a position between bowl 14 and tank 16 and at least selectively moveable to a position proximate tank 16 (see FIG. 3).

In the present example, interaction face 22 is recessed into support member 20 and is distal tank 16 when support member 20 is in a position proximate tank 16. Further, because interaction face 22 is recessed into support member 20, it is configured to receive a variety of different interactive features 30. Here, electronic device 31 is positioned against interaction face 22 and a plurality of hook-and-loop strips 24 longitudinally adhered to interaction face 22 and on the backside (not shown) of interactive feature 30, which function to hold interactive feature 30 securely in place.

Further, hook-and-loop straps 26 are removably affixed to opposing sides of support member 20 and can be adjusted to fit snugly against toilet lid 12 by cinching up and securing the excess strap material as shown in FIG. 3. In other examples, the support member may be temporarily attached to the toilet lid by any other interchangeable strapping means.

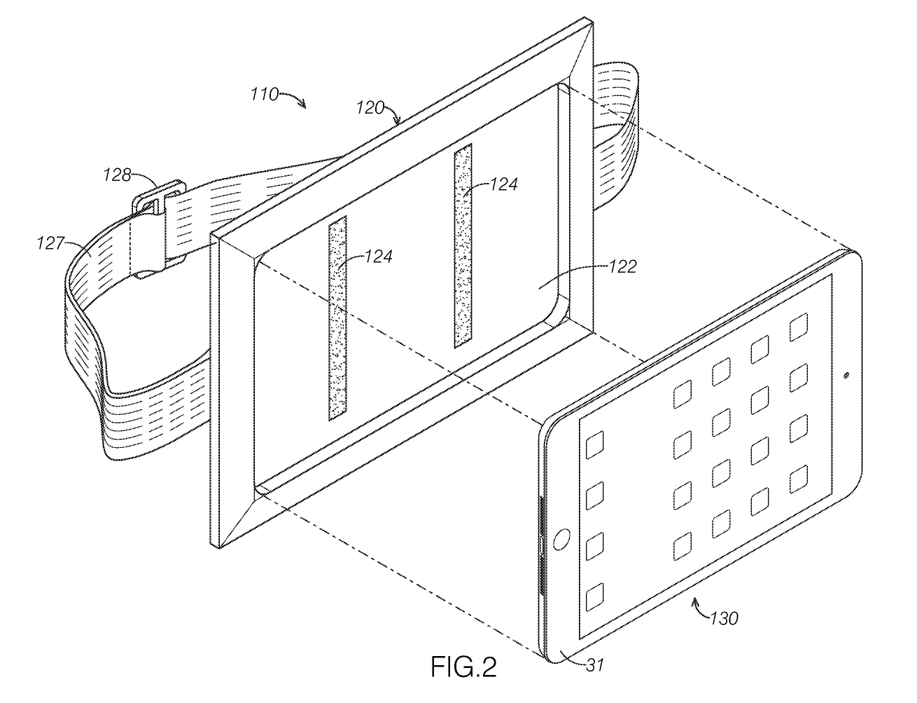

Turning attention to FIG. 2, a second example of a toilet training apparatus 110 will now be described. Toilet training apparatus 110 includes man similar or identical features to toilet training apparatus 10. Thus, for the sake of brevity, each feature of toilet training apparatus 110 will not be redundantly explained. Rather, key distinctions between toilet training apparatus 110 and toilet training apparatus 10 be described in detail and the reader should reference the discussion above for features substantially similar between the two toilet training apparatuses.

As can be seen in FIG. 2, toilet training apparatus 110 includes a support member 120 and an interaction feature 130. In this example, toilet training apparatus 110 is affixed to toilet lid 12 with an elastic band 127, whereas toilet training apparatus 10 is affixed to toiled lid 12 through the use of hook-and-loop straps 26 (see FIG. 1).

Support member 120 of toilet training apparatus 110 includes elastic band 127. Elastic band 127 is removably affixed to opposing sides of support member 120 and can be adjusted to fit snugly against toilet lid 12 by use of a slide buckle 128. In other examples, the support member may be temporarily attached to the toilet lid by any other adjustable strapping means.

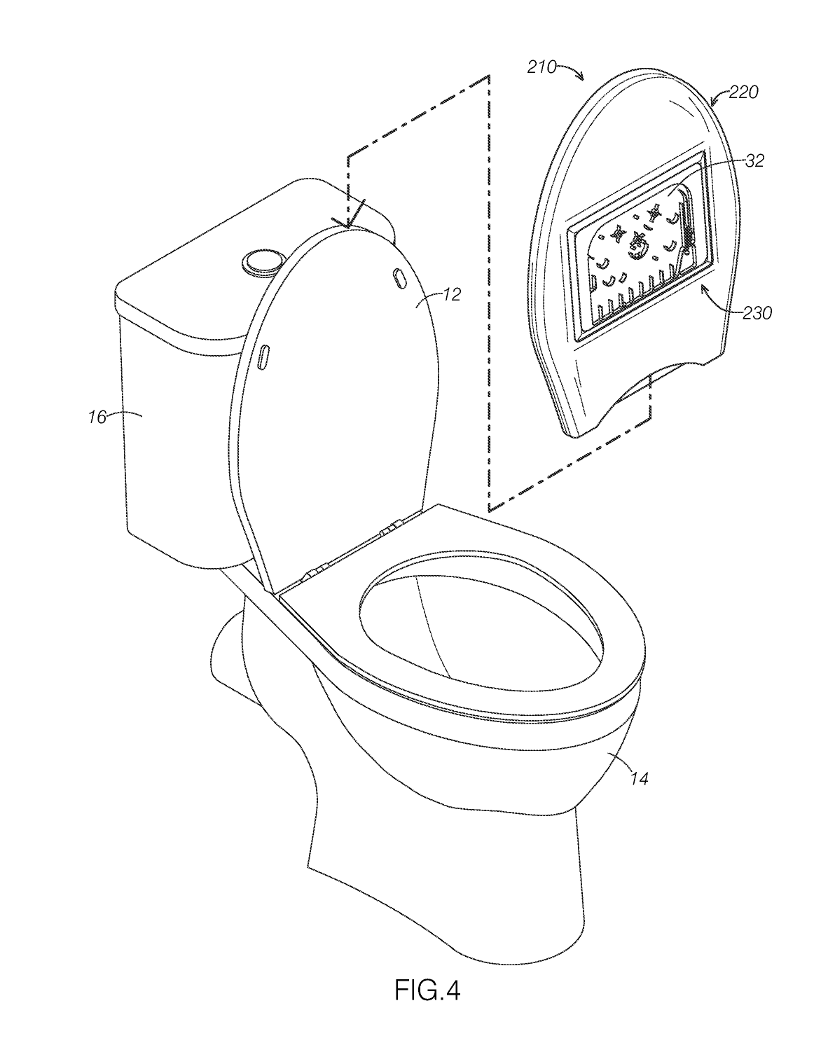

Turning attention to FIG. 4, a third example of a toilet training apparatus 21 now be described. Toilet training apparatus 210 includes many similar or identical features to toilet training apparatus 10. Thus, for the sake of brevity, each feature of toilet training apparatus 210 will not be redundantly explained. Rather, key distinctions between toilet training apparatus 210 and toilet training apparatus 10 will be described in detail and the reader should reference the discussion above for features substantially similar between the two toilet training apparatuses.

As can be seen in FIG. 4, toilet training apparatus 210 includes a support member 220, and an interaction feature 230. In this example, support member 220 of toilet training apparatus 210 is an integrally formed sleeved member that is substantially the same shape as toilet lid 12 and is configured to be inserted over toilet lid 12, as opposed to being attached by either Hook-and-loop straps 26 or an elastic band 127 as previously described.

Further, support member 220 is configured to receive a variety of different interaction features 230, such as a pinball-type game 32. Support member 220 may be made of any semi-rigid, pliable material, including, but not limited to, polyurethane elastomers, high-density polyethylene (HDPE), or polyethylene high-density (PEHD) type materials. In other examples, an etch-a-sketch game 34 (see FIG. 9) or a dry-erase board 36 (see FIG. 9) may also be used with toilet training apparatus 210.

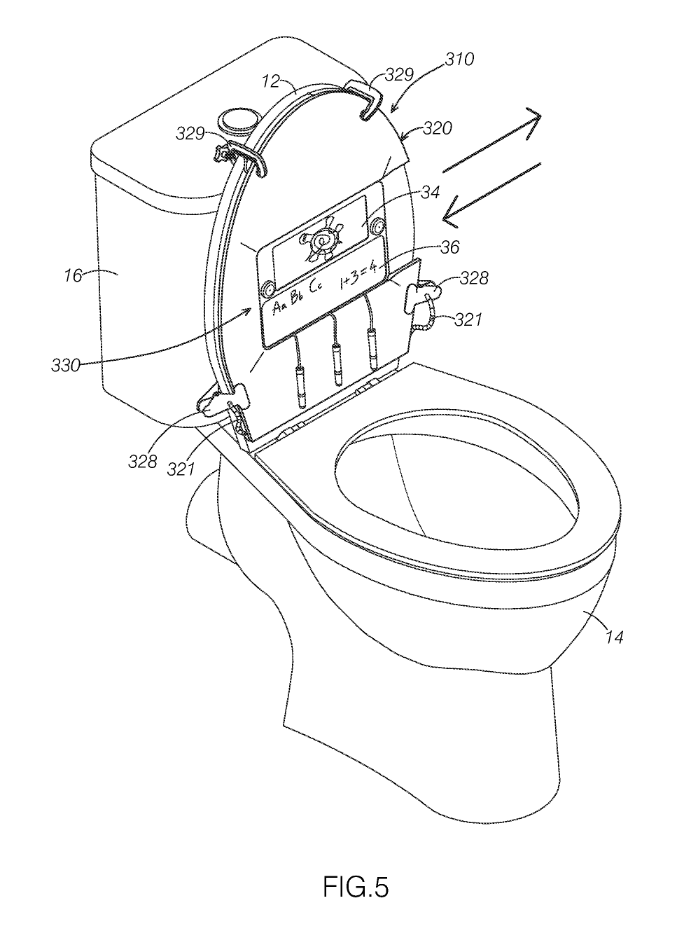

Turning attention to FIG. 5, a fourth example of a toilet training apparatus 310 will now be described. Toilet training apparatus 310 includes many similar or identical features to toilet training apparatus 210. Thus, for the sake of brevity, each feature of toilet training apparatus 310 will not be redundantly explained. Rather, key distinctions between toilet training apparatus 310 and toilet training apparatus 210 will be described in detail and the reader should reference the discussion above for features substantially similar between the two toilet training apparatuses.

As can be seen in FIG. 5, toilet training apparatus 310 includes a support member 320 and an interaction feature 330. In this example, support member 320 defines a substantially rectangular cutout configured to slidably receive interaction feature 330, whereas support member 220 is integrally formed with a sleeve member in the previously described toilet training apparatus 210.

Support member 320, which is substantially shaped to conform to toilet lid 12, is affixed to toilet lid 12 with a plurality of spring-loaded clamps 328 and/or a plurality of screw clamps 329. Each of the spring-loaded claims 328 or screw clamps 329 is configured to permanently attach to support member 320 through the use of a plurality of flexible members 321. Flexible members 321 are integrally formed with spring-loaded clamps 328 or screw clamps 329. One end of flexible members 321 is attached to spring-load clamp 328 or screw damp 329, while the other end is permanently attached to support member 320. Flexible members 321 allow for ease of positioning of spring-loaded damps 328 and screw clamps 320 when attaching support member 320 to lid 12, as well as reducing the Possibility that both types of clamps do not fall into toilet bowl 14.

Support member 320 may be made of any semi-rigid, pliable material, including, but not limited to, polyurethane elastomers, high-density polyethylene (HDPE), or polyethylene high-density (PEHD) type materials.

Further, support member 320 is configured to slidably receive a variety of interaction features 330. An interaction feature 330, such as a combination etch-a-sketch 34 and dry-erase board 36 may be slidably inserted into rectangular cutout of support member 320. In other examples, an electronic device may be inserted into the support member.

Turning attention to FIG. 6, a fifth example of a toilet training apparatus 210 will now be described. Toilet training apparatus 410 includes many similar or identical features to toilet training apparatus 210. Thus, for the sake of brevity, each feature of toilet training apparatus 410 will not be redundantly explained. Rather, key distinctions between toilet training apparatus 410 and toilet training apparatus 210 will be described in detail and the reader should reference the discussion above for features substantially similar between the two toilet training apparatuses.

As can be seen in FIG. 6, toilet training apparatus 410 includes a support member 420 and an interaction feature 430. In this example, support member 420 is integrally formed with lid 12, whereas support member 220 of toilet training apparatus 210 is integrally formed with a sleeve member.

Support member 420 is integrally formed with toilet lid 12 and defines an interaction face 422 (not shown) that allows for the insertion of electronic device 31. Toilet lid 12 may be made of any conventional toilet lid materials. Further, in other examples, the interaction feature may include, an etch-a-sketch game, a pinball game, or a dry-erase board.

The disclosure above encompasses multiple distinct inventions with independent Utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims whether they are directed to the same invention or a different invention and whether they are different, broader, narrower or equal in scope to the original claims, are to be considered within the subject matter of the inventions described herein.

I Claim:

1. A toilet training apparatus for use by a user with a toilet including a bowl and a tank when the user is facing the tank and sitting on or squatting above the bowl, comprising:
a support member mounted to the toilet iii in a position between the bowl and the tank and at least selectively moveable to a position proximate the tank, the support member including an interaction face distal the tank when the support member is in a position proximate the tank; and
an interaction feature supported on the interaction face of the support member and configured to entertain the user as the user interacts with the interaction feature when the user is facing the tank and sitting on or squatting above the bowl.

2. The toilet training apparatus of claim 1, wherein the support member defines a lid configured to pivotally mount to the bowl and selectively move between a closed position proximate the bowl and an open position proximate the tank.

3. The toilet training apparatus of claim 1, wherein:
the toilet further includes a lid pivotally mounted to the bowl and selectively moveable between a closed position proximate the bowl and an open position proximate the tank; and
the support member is configured to selectively secure to the lid.

4. The toilet training apparatus of claim 3, wherein the support member is removably affixed to the lid with a plurality of Hook-and-loop straps.

5. The toilet training apparatus of claim 3, wherein the support member is removably affixed to the lid with a plurality of elastic bands.

6. The toilet training apparatus of claim 3, wherein the support member is integrally formed with a sleeve member, the sleeve member being configured to slidably attach to the lid.

7. The toilet training apparatus of claim 3, wherein the support member is a rigid member that is substantially the same shape as the lid, the rigid member being configured to removably attach to the lid.

8. The toilet training apparatus of claim 7, wherein the support member defines a substantially rectangular cutout configured to receive the interaction feature.

9. The toilet training apparatus of claim 7, further comprising a plurality of clamps configured to removably attach the support member to the lid.

10. The toilet training apparatus of claim further comprising a plurality of screw fasteners configured to removably attach the support member to the lid.

11. The toilet training apparatus of claim 1, wherein the interaction feature is an electronic device.

12. The toilet training apparatus of claim 1, wherein the interaction feature is an etch-a-sketch game, a pinball game, a dry-erase board, or a magnetic board.

13. A toilet training apparatus for use by a user with a toilet including a bowl, a lid and a tank when the user is facing the tank and sitting on or squatting above the bowl, comprising:
an interaction face, the interaction face integrally formed with the lid, the lid configured to pivotally mount to the bowl and selectively more between a closed position proximate the bowl and an open position proximate the tank; and
an interaction feature supported on the interaction face of the lid and configured to entertain the user as the user interacts with the interaction feature when the user is facing the tank and sitting on or squatting above the bowl.

14. The toilet training apparatus of claim , wherein the interaction feature is an electronic device.

15. The toilet training apparatus of claim 13, wherein the interaction feature is a magnetic board, a pinball game, a dry-erase board, or an etch-a-sketch game.

16. A toilet training apparatus for use by a user with a toilet including a bowl, a lid and a tank when the user is facing the tank and sitting on or squatting above the bowl, comprising:
a support member with means for removably mounting the support member to the lid, the support member including an interaction face distal the tank when the support member is in a position proximate the tank; and
interaction feature supported on the interaction face of the support member and configured to entertain the user as the user interacts with the interaction feature when the user is facing the tank and sitting on or squatting above the bowl.

17. The toilet training apparatus of claim 16, wherein the interaction feature is an electronic device.

18. The toilet training apparatus of claim 16, wherein the interaction features is a pinball game, an etch-a-sketch game, a dry-erase board, or a magnetic board.
